(19) United States
(12) Patent Application Publication
(10) Pub. No.: US 2011/0067512 A1
(43) Pub. Date: Mar. 24, 2011

(54) COAXIAL MULTI-CLUTCH TRANSMISSION

(76) Inventors: Myungkoo Kang, Busan (KR); Hyo Jeong Jeon, Busan (KR); Seungmo Kang, Busan (KR); Suejeong Kang, Busan (KR)

(21) Appl. No.: 12/783,282

(22) Filed: May 19, 2010

(30) Foreign Application Priority Data
Sep. 18, 2009 (KR) 10-2009-0088525
Mar. 10, 2010 (KR) 10-2010-0021226

(51) Int. Cl. F16H 3/08

(52) U.S. Cl. 74/330

(57) ABSTRACT

Disclosed herein is a coaxial multi-clutch transmission which can enhance fuel efficiency. The transmission includes a main input shaft, a first input shaft, a second input shaft, a first clutch, a second clutch, a power transmitting gear unit, an output shaft, drive gears and driven gears. The first and second input shafts have a coaxial structure and are power-connected to the main input shaft. The first clutch is provided on the first input shaft to control power connection between the main input shaft and the first input shaft. The second clutch is provided on the second input shaft to control power connection between the main input shaft and the second input shaft. The power transmitting gear unit functions to transmit power to the first clutch and the second clutch.

### BACKGROUND OF THE INVENTION

1. Field of the Invention

The present invention relates generally to coaxial multi-clutch transmissions and, more particularly, to a coaxial multi-clutch transmission in which the combination or arrangement of clutches can be freely changed, and a dry single-plate clutch can be used for each clutch without restriction, and which can prevent an energy loss of a hydraulic regulator resulting from a wet multi-plate clutch structure, thus enhancing fuel efficiency, and which enhances the maximum allowed torque thanks to the use of the dry single-plate clutch and a separate main clutch and can thus be used in large vehicles, such as buses or trucks, and can also markedly reduce the overall size of the transmission.

2. Description of the Related Art

Developing techniques for enhancing fuel efficiency and reducing pollution is one of most important issues facing recent automobile technology. Pollution resulting from the exhaust gas of vehicles is regulated by standards (for example, EURO 6, Tier 3, etc.) depending on the continent. Recently, because of the sudden rise in oil prices, improving the fuel efficiency of vehicles has become the most important subject in related industries. For instance, recent automobile companies attend to the development and deployment of more efficient electric vehicles or hybrid vehicles and are conducting a lot of research into the improvement of the vehicle environment such that fuel efficiency can be enhanced and the expelling of polluting gases can be reduced to cope with problems regarding fuel and pollution based on the current internal-combustion engine technology. Such technical efforts are still focusing on engines which directly consume fuel, but many attempts are multilaterally being conducted on several areas other than the engine.

Specially, several transmission technologies which were recently developed by a new type of methods have solved important problems faced by existing transmissions. Transmissions are classified into manual transmissions (MT), automatic transmissions (AT), continuously variable transmissions (CVT), and automated manual transmissions (AMT) and dual-clutch transmissions (DCT) which have recently been developed.

The DCT is an improvement over automated manual transmissions. Taking advantage of the high economic efficiency of a manual transmission, the DCT reduces power loss. Furthermore, a sport-oriented driving experience is made possible thanks to rapid gear shifting. Thus, the DCT has recently gained in popularity. Such DCTs have been used since 2003 in mass-produced vehicles. At present, the DCTs are most widely used in the DSGs (direct shift gearboxes) of Volkswagen, Inc., which are based on Borg Warner's Dualtronic technology.

The DCT is similar to the AMT in that shifting is conducted by an electronic hydraulic device based on a manual transmission structure, but there is a large difference therebetween in structural characteristics. In the manual transmission, shifting is conducted in such a way that a clutch is disengaged to interrupt power connection from a state in which gears are in the engaged state, and the gears are shifted to a desired gear ratio, and then the clutch is engaged again to make power connection. At this time, to offset a difference between rpms of two corresponding gears, an operation of bringing the rpms into sync with each other by controlling the accelerator is required. In the manual transmission, these operations are conducted by the hands and feet of a driver. In the case of the AMT, the electronic hydraulic device conducts this operation. Here, in the case where a single clutch is used, disengagement of the clutch, selection of a gear ratio, and engagement of the clutch must be conducted in succession. Therefore, there is a limitation imposed on increasing the speed of gear shifting. Depending on the method of controlling the clutch, shift shock may occur.

FIG. 1 is a view showing the construction of a representative example of a conventional coaxial dual-clutch transmission. The term “dual-clutch transmission (DCT)” is used to mean that the DCT is characterized in that there are two clutches C1 and C2 unlike in manual transmissions (MT) or automated manual transmissions (AMT). With reference to the drawing showing a DSG (PDK; Porsche Doppelkupplung) of Volkswagen, Inc., the two clutches C1 and C2 respectively govern power transmission of odd-numbered speed gears D1, D3 and D5 and even-numbered speed gears D2, D4 and D6. Furthermore, when any gear ratio is selected, gears corresponding to the gear ratios adjacent to the selected gear ratio enter a pre-select state in which it is previously connected to an input shaft IS1 or IS2 adjacent to the engine. For instance, when the first gear D1 for a first gear ratio is selected, the first clutch C1 which governs the odd-numbered speed gears are engaged to transmit power, and the second gear D2 is also rotated along with the first gear D1. However, because the second clutch C2 which governs the even-numbered speed gears is in the disengaged state, power is not transmitted through the second gear D2 although the second gear D2 is rotating. When shifting from first to second gear, the first clutch C1 is disengaged and the second clutch C2 is simultaneously engaged so that the second gear D2 enters the engaged state.

As such, every time gears are shifted, connecting one of the clutches to transmit power and disconnecting the other clutch to interrupt power are conducted at almost the same time. Thus, the time required for shifting is reduced. In addition, the shift shock occurring when one clutch is engaged is offset against the shift shock occurring when the other clutch is disengaged, so that the entire shift shock is markedly reduced. In the DCT, it takes about 8 ms to 10 ms to shift the gears. It can be understood that the time required for shifting is markedly reduced compared to that of the AMT. Furthermore, power loss of the DCT is less than that of the manual transmission, so that fuel efficiency can be markedly improved. Due to these characteristics, the world's most eminent vehicle manufacturers and transmission manufacturers are focusing on the development and production of DCTs. In addition, these manufacturers have been faced with keen competition.

FIG. 2 is a view showing the construction of another example of a conventional coaxial dual-clutch transmission, which was proposed in Korean Patent Laid-open Publication No. 10-2006-0049939. The basic construction of this coaxial dual-clutch transmission is similar to that of the coaxial dual-clutch transmission of FIG. 1. One notable difference in the transmission of FIG. 1, however, is that the two output shafts OS1 and OS2 are provided parallel to the first and second input shafts which form a coaxial structure, but in the transmission of FIG. 2, a single counter shaft 18 is disposed below two first and second input shafts 14 and 16 which form a coaxial structure.

However, the conventional coaxial DCT which has these advantages also has several serious disadvantages, including the problem of relatively low fuel efficiency. As shown in FIGS. 1 and 2, it seems in theory that the fuel efficiency of the coaxial DCT is superior than that of the manual transmission. However, substantially, the fuel efficiency of the conventional coaxial DCT is superior than that of the automatic transmission but inferior to that of a manual transmission. The reason for this is because of the presence of a hydraulic pressure controller which controls a wet clutch and gear selectors (synchronizers; referred to as reference character S of FIG. 1, and reference numerals 74, 76, 76, 78 and 89 of FIG. 2).

In detail, the hydraulic pressure controller is operated by some of the energy output from the engine, thus resulting in parasitic energy consumption. Recently, alongside the development of computer control technology, various functions of vehicles which had been manually operated have been automated. The technique of using the wet clutch and the gear selector was introduced on the basis of the development of the computer control technology. The wet clutch typically has a multi-plate structure and is controlled by the hydraulic pressure controller. On the other hand, a dry clutch has a single-plate structure and is controlled by an electric motor. In the above-mentioned conventional coaxial DCTs, wet multi-plate clutches are used for all the clutches (C1 of FIG. 1, or 32 and 33 of FIG. 2), because the entire volume of the coaxial DCT is limited. In other words, in the conventional coaxial DCTs, only small wet multi-plate clutches can be used in the clutch casing (CC of FIG. 1, or 28 and 36 of FIG. 2) because of the structural characteristics of the coaxial DCT. However, because the wet multi-plate clutch uses oil to cool the clutch, power loss is unavoidable. Furthermore, due to the small size of the wet multi-plate clutch, it is limited to increase the maximum allowed torque of the clutch.

Moreover, the wet multi-plate clutch is controlled by the hydraulic pressure controller. Here, the hydraulic pressure controller causes parasitic energy consumption of the output of the engine, thus reducing fuel efficiency. On the other hand, the electric motor is operated by electricity supplied from a storage battery. Therefore, the fuel efficiency of the dry clutch is higher than that of the wet clutch. Particularly, in the case of a vehicle, such as a hybrid vehicle, having a power supply system in which mechanical energy is converted into electric energy when the vehicle decelerates or moves on a downward slope, the fuel efficiency of the dry clutch can be further enhanced.

To date, in DCTs having the coaxial shaft structure in which one rotational shaft is provided inside the other rotational shaft having a hollow structure, there is no example using a dry clutch. That is, because of the structural characteristics of the DCT, the dry clutch could not be used. Therefore, an improved coaxial multi-clutch transmission which is configured such that a dry clutch can be used to enhance the fuel efficiency of the transmission and in which the maximum allowed torque of the transmission could be enhanced was required. With regard to this, a technique used to solve the several problems of the above-mentioned prior techniques was proposed in Korean Patent Application No. 10-2009-0088525 which was filed by the applicant of the present invention.

### PRIOR ART DOCUMENT

### Patent Document

Korean Patent Laid-open Publication No. 10-2006-0049939, Korean Patent Registration No. 10-0901608, Korean Patent Application No. 10-2009-0088525

### SUMMARY OF THE INVENTION

Accordingly, the present invention has been made keeping in mind the above problems occurring in the prior art, and an object of the present invention is to provide a coaxial multi-clutch transmission which can overcome the problems of low energy efficiency and low maximum allowed torque that are induced in the conventional coaxial dual-clutch transmission which must use only wet multi-plate clutches because of structural characteristics.

Another object of the present invention is to provide a coaxial multi-clutch transmission in which clutches can be combined and arranged in various manners regardless of the kind of clutches, that is, whether the clutches are dry clutches or wet clutches.

Another object of the present invention is to provide a coaxial multi-clutch transmission which can markedly reduce the entire size despite taking advantage of the conventional techniques.

In order to accomplish the above object, in an aspect, the present invention provides a coaxial multi-clutch transmission providing speed and torque conversions from an engine to an output unit. The transmission includes a main input shaft, a first input shaft and a second input shaft, a first clutch, a second clutch, a power transmitting gear unit, an output shaft, a plurality of drive gears and a plurality of driven gears. The main input shaft is coupled to a flywheel to receive rotational force from the engine. The first input shaft and the second input shaft are disposed behind the main input shaft so as to be rotatable. The first and second input shafts are power-connected to the main input shaft such that the rotational force is transmitted from the main input shaft to the first or second input shaft. The second input shaft has a hollow shaft structure which is coaxial with the first input shaft and rotatably receives the first input shaft therein. The first clutch is provided on the first input shaft and allows power connection from the main input shaft to the first input shaft or interrupts the power connection therebetween. The second clutch is provided on the second input shaft and allows power connection from the main input shaft to the second input shaft or interrupts the power connection therebetween. The power transmitting gear unit includes a first front gear which is rotatably provided on the main input shaft between the flywheel and the first clutch, a first rear gear which is rotatably provided on a front end of the second input shaft, a middle shaft which is provided parallel to the main input shaft, a second front gear which is rotatably provided on the middle shaft and engages with the first front gear, and a second rear gear which is rotatably provided on the middle shaft and engages with the first rear gear. The output shaft is provided parallel to the first and second input shafts which are coaxial and disposed at a position spaced apart from the first and second input shafts. The drive gears rotatably provided on the first input shaft and the second input shaft. The driven gears are rotatably provided on the output shaft and engage with the corresponding drive gears.

In another aspect, the present invention provides a coaxial multi-clutch transmission providing speed and torque conversions from an engine to an output unit. The transmission includes a main input shaft, a first input shaft and a second input shaft, a first clutch, a second clutch, a power transmitting gear unit, an output shaft, a plurality of drive gears and a plurality of driven gears. The main input shaft is coupled to a flywheel to receive rotational force from the engine. The first input shaft and the second input shaft are disposed behind the main input shaft so as to be rotatable. The first and second input shafts are power-connected to the main input shaft such that the rotational force is transmitted from the main input shaft to the first or second input shaft. The second input shaft has a hollow shaft structure which is coaxial with the first input shaft and rotatably receives the first input shaft therein. The first clutch is provided on the first input shaft and allows power connection from the main input shaft to the first input shaft or interrupts the power connection therebetween. The second clutch is provided on the second input shaft allows power connection from the main input shaft to the second input shaft or interrupts the power connection therebetween. The power transmitting gear unit includes an auxiliary shaft which is provided parallel to the main input shaft, a front power transmitting gear which is rotatably provided on the auxiliary shaft and engages with the first clutch, and a rear power transmitting gear which is rotatably provided on the auxiliary shaft and engages with the second clutch. The output shaft is provided parallel to the first and second input shafts which are coaxial and disposed at a position spaced apart from the first and second input shafts. The drive gears rotatably provided on the first input shaft and the second input shaft. The driven gears are rotatably provided on the output shaft and engage with the corresponding drive gears.

In another aspect, the present invention provides a coaxial multi-clutch transmission providing speed and torque conversions from an engine to an output unit. The transmission includes a main input shaft, a first input shaft and a second input shaft, a first clutch, a second clutch, a center clutch plate, a power transmitting gear unit, an output shaft, a plurality of drive gears and a plurality of driven gears. The main input shaft is coupled to a flywheel to receive rotational force from the engine. The first input shaft and the second input shaft are disposed behind the main input shaft so as to be rotatable. The first and second input shafts are power-connected to the main input shaft such that the rotational force is transmitted from the main input shaft to the first or second input shaft. The second input shaft has a hollow shaft structure which is coaxial with the first input shaft and rotatably receives the first input shaft therein. The first clutch is provided on the first input shaft. The second clutch is provided on the second input shaft. The center clutch plate is provided between the first clutch and the second clutch and is engaged with or disengaged from the first clutch or the second clutch to transmit the rotational force from the main input shaft to the first input shaft or the second input shaft. The power transmitting gear unit includes a front gear which is provided between the main input shaft and the first clutch and is rotatably mounted to the main input shaft, a power supply shaft which is provided parallel to the main input shaft, a front supply gear which is rotatably provided on the power supply shaft and engages with the front gear, and a rear supply gear which is rotatably provided on the power supply shaft and engages with the center clutch plate. The output shaft is provided parallel to the first and second input shafts which are coaxial and disposed at a position spaced apart from the first and second input shafts. The drive gears rotatably provided on the first input shaft and the second input shaft. The driven gears are rotatably provided on the output shaft and engage with the corresponding drive gears.

In yet another aspect, the present invention provides a coaxial multi-clutch transmission providing speed and torque conversions from an engine to an output unit. The transmission includes a main input shaft, a first input shaft and a second input shaft, a first clutch, a second clutch, a center clutch plate, a power supply gear, an output shaft, a plurality of drive gears and a plurality of driven gears. The main input shaft is coupled to a flywheel to receive rotational force from the engine. The first input shaft and the second input shaft are disposed behind the main input shaft so as to be rotatable. The first and second input shafts are provided parallel to the main input shaft and power-connected to the main input shaft such that the rotational force is transmitted from the main input shaft to the first or second input shaft. The second input shaft has a hollow shaft structure which is coaxial with the first input shaft and rotatably receives the first input shaft therein. The first clutch is provided on the first input shaft. The second clutch is provided on the second input shaft. The center clutch plate is provided between the first clutch and the second clutch and is engaged with or disengaged from the first clutch or the second clutch to transmit the rotational force from the main input shaft to the first input shaft or the second input shaft. The power supply gear is rotatably mounted to the main input shaft and engages with the center clutch plate. The output shaft is provided parallel to the first and second input shafts which are coaxial and disposed at a position spaced apart from the first and second input shafts. The drive gears rotatably provided on the first input shaft and the second input shaft. The driven gears are rotatably provided on the output shaft and engage with the corresponding drive gears.

Of the plurality of drive gears, even-numbered speed drive gears may be provided on the first input shaft, and odd-numbered speed drive gears may be provided on the second input shaft.

Of the plurality of drive gears, odd-numbered speed drive gears may be provided on the first input shaft, and even-numbered speed drive gears may be provided on the second input shaft.

The coaxial multi-clutch transmission may further include a main clutch provided between the flywheel and the first clutch. The main clutch may have a diameter greater than a diameter of each of the first and second clutches.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the construction of an example of a conventional coaxial dual-clutch transmission;

FIG. 2 is a view showing the construction of another example of a conventional coaxial dual-clutch transmission;

FIG. 3 is a schematic view illustrating a coaxial multi-clutch transmission, according to a first embodiment of the present invention;

FIG. 4 is a schematic view illustrating a coaxial multi-clutch transmission, according to a second embodiment of the present invention;

FIG. 5 is a schematic view illustrating a coaxial multi-clutch transmission, according to a third embodiment of the present invention;

FIG. 6 is a schematic view illustrating a coaxial multi-clutch transmission, according to a fourth embodiment of the present invention;

FIG. 7 is a schematic view illustrating a coaxial multi-clutch transmission, according to a fifth embodiment of the present invention;

FIG. 8 is a schematic view illustrating a coaxial multi-clutch transmission, according to a sixth embodiment of the present invention;

FIG. 9 is a schematic view illustrating a coaxial multi-clutch transmission, according to a seventh embodiment of the present invention;

FIG. 10 is a schematic view illustrating a coaxial multi-clutch transmission, according to an eighth embodiment of the present invention;

FIG. 11 is a schematic view illustrating a coaxial multi-clutch transmission, according to a ninth embodiment of the present invention;

FIG. 12 is a schematic view illustrating a coaxial multi-clutch transmission, according to a tenth embodiment of the present invention;

FIG. 13 is a schematic view illustrating a coaxial multi-clutch transmission, according to an eleventh embodiment of the present invention;

FIG. 14 is a schematic view illustrating a coaxial multi-clutch transmission, according to a twelfth embodiment of the present invention;

FIG. 15 is a schematic view illustrating a coaxial multi-clutch transmission, according to a thirteenth embodiment of the present invention;

FIG. 16 is a schematic view illustrating a coaxial multi-clutch transmission, according to a fourteenth embodiment of the present invention;

FIG. 17 is a schematic view illustrating a coaxial multi-clutch transmission, according to a fifteenth embodiment of the present invention; and

FIG. 18 is a Schematic view illustrating a coaxial multi-clutch transmission, according to a sixteenth embodiment of the present invention.

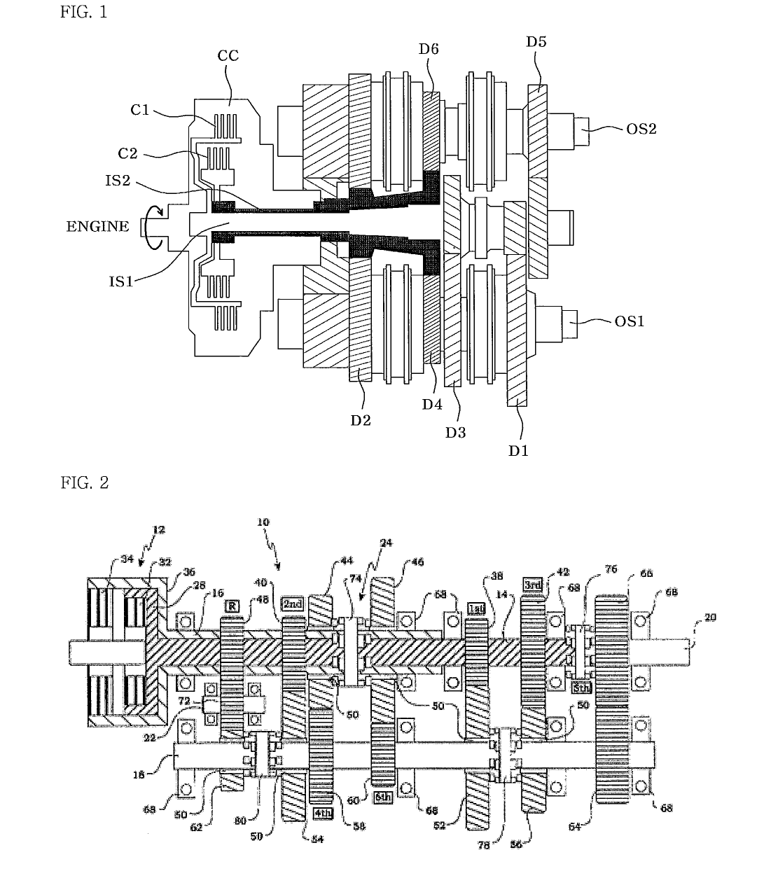

### DESCRIPTION OF THE PREFERRED EMBODIMENTS

Hereinafter, preferred embodiments of the present invention will be described in detail with reference to the attached drawings. FIG. 3 is a schematic view illustrating a coaxial multi-clutch transmission, according to a first embodiment of the present invention. In the first embodiment of the present invention, clutches are respectively coupled to two coaxial input shafts and alternately and selectively transmit power, thus reducing the time required for shifting and enhancing the energy efficiency.

With reference to FIG. 3, the coaxial multi-clutch transmission according to the first embodiment includes a main input shaft MIS, a first input shaft IS1, a second input shaft IS2, a first clutch C1, a second clutch C2, a power transmitting gear unit, a plurality of drive gears G1 through G8, an output shaft OS and a plurality of driven gears D1 through D7 and R. The main input shaft MIS is coupled to a flywheel FW and directly receives rotating force from an engine. The first input shaft IS1 is provided such that the axis thereof is aligned with the axis of the main input shaft MIS. The second input shaft IS2 has a hollow shaft structure which is coaxial with the first input shaft IS1. The first clutch C1 controls the power connection of the first input shaft IS1. The second clutch C2 controls the power connection of the second input shaft IS2. The power transmitting gear unit includes a middle shaft MS and four gears (a first front gear FG2, a second front gear FG2, a first rear gear RG1 and a second rear gear RG2) which transmit the rotating force of the main input shaft MIS to the first and second input shafts IS1 and IS2. The drive gears G1 through G8 are rotatably provided on the first and second input shafts IS1 and IS2. The output shaft OS is parallel to the input shafts IS1 and IS2 and is spaced apart therefrom by a predetermined distance. The driven gears D1 through D7 and R are provided on the output shaft OS and respectively engage with the drive gears G1 through G8.

The first clutch C1 is provided on the first input shaft IS1 and couples the first input shaft IS1 to the main input shaft MIS to transmit power therebetween or decouples the first shaft IS1 from the main input shaft MIS to interrupt power transmission therebetween. The second clutch C2 is provided on the second input shaft IS2 and couples the second input shaft IS2 to the main input shaft MIS to transmit power therebetween or decouples the second input shaft IS2 from the main input shaft MIS to interrupt power transmission therebetween. It is preferable that a dry single-plate clutch be used as each of the first and second clutches C1 and C2, but this is not limited thereto. For example, a wet multi-plate clutch may be used. As necessary, the two kinds of clutches may be combined.

In the present invention, the power transmitting gear unit is used to facilitate application of a dry single-plate clutch structure to a coaxial dual-clutch transmission structure. In detail, the first front gear FG1 is rotatably provided on the main input shaft MIS between the flywheel FW and the first clutch C1. The first rear gear RG1 is rotatably provided on the front end of the second input shaft IS2. The middle shaft MS is provided below the main input shaft MIS at a position spaced apart therefrom by a predetermined distance and is parallel to the main input shaft MIS. The second front gear FG2 and the second rear gear RG2 are rotatably provided on the middle shaft MS. The second front gear FG2 engages with the first front gear FG1. The second rear gear RG2 engages with the first rear gear RG1. The rotating force of the main input shaft MIS is transmitted to the first and second input shafts IS1 and IS2 through the first and second front gears FG1 and FG2 and the first and second rear gears RG1 and RG2. The transmission of the rotating force from the main input shaft MIS to the first or second input shaft IS1 or IS2 is selectively controlled by the first and second clutches C1 and C2.

As shown in the drawing, the even-numbered speed drive gears G2, G4, G6 and G8 are provided on the first input shaft IS1. The odd-numbered speed drive gears G1, G3, G5 and G7 are provided on the second input shaft IS2. The output shaft OS is disposed below the first and second input shafts IS1 and IS2 at a position spaced apart therefrom and is parallel thereto. The odd-numbered speed driven gears D1, D3, D5 and D7 and the even-numbered speed driven gears D2, D4, D6 and R are provided on the output shaft OS. The Arabic numeral following the alphabets of the reference characters denoting each drive gear or each driven gear designates a corresponding gear ratio (speed). The driven gears provided on the output shaft OS respectively engage with the drive gears which are provided on the first and second input shafts IS1 and IS2 and correspond to the respective gear ratios. Meanwhile, synchronizers (or synchromeshes) S1, S2, S3 and S4 are slidably provided on the corresponding input shafts IS1 and IS2 between the drive gears G1 through G8. The synchronizers S1, S2, S3 and S4 are selectively coupled to the corresponding drive gears G1 through G8 to control the transmission of power. The synchronizers S1, S2, S3 and S4 are connected to a separate actuator (not shown) and controlled by an electronic control unit.

The operational mechanism of the coaxial dual-clutch transmission according to the first embodiment of the present invention will be described in detail with reference to FIG. 3.

The first and second clutches C1 and C2 respectively selectively transmit rotational force (torque and rotational speed) of the main input shaft MIS to the first input shaft IS1 and the second input shaft IS2. In other words, when the main clutch MC is in an engaged state, if the first clutch C1 is engaged, the rotational force of the main input shaft MIS is transmitted to the first input shaft IS1. In this case, the second clutch C2 is maintained in a disengaged state. If the second clutch C2 is engaged, the rotating force of the main input shaft MIS is transmitted to the second input shaft IS2, and the first clutch C1 enters a disengaged state. The output shaft OS is connected to a differential gear (not shown) to transmit the rotational force of the main input shaft MIS to the wheels via the transmission.

A dry single-plate clutch is used as each of the first and second clutches C1 and C2. The size (diameter) of the second clutch C2 which governs the odd-numbered speed drive gears including the first gear ratio is greater than that of the first clutch C1 which governs the even-numbered speed drive gears. The reason for this is because the largest amount of torque (load) is applied to the transmission when in first gear. Therefore, the second clutch C2 which controls coupling or decoupling of the second input shaft IS2 related to the first gear ratio must be set in a size sufficient to withstand a very large amount of torque resulting from a load, such as static friction.

When in first gear, the first drive gear G1 which engages with the first driven gear D1 makes the power connection. In detail, the rotational force of the engine is transmitted to the second input shaft IS2 via the main input shaft MIS and the first and second front gears FG1 and FG2 and the first and second rear gears RG1 and RG2 of the power transmitting gear unit. In this case, the first clutch C1 is disengaged, and the second clutch C2 is engaged. In addition, the first synchronizer S1 is coupled to the first drive gear G1 to transmit the rotational force to the first drive gear G1. Because the first drive gear G1 engages with the first driven gear D1, the rotational force of the engine is transmitted to the differential gear (not shown) via the first driven gear D1 and the output shaft OS. During this process, the second synchronizer S2 is selected beforehand and maintains the state of being engaged with the second drive gear G2 to prepare shifting to the next gear. This is called a “pre-select” state. However, although the second drive gear G2 is in the pre-select state, because the first clutch C1 which is connected to the first input shaft IS1 is in the disengaged state, the rotational force of the main input shaft MIS is not transmitted to the second drive gear G2. In other words, the second drive gear G2 maintains an idle state.

When in second gear, the second drive gear G2 which engages with the second driven gear D2 makes a power connection. In detail, when shifting to second gear, the second clutch C2 is disengaged, and the first clutch C1 is engaged. At this time, because the second drive gear G2 has been in the pre-select state, the rotational force is transmitted to the second driven gear D2 as soon as the first clutch C1 is engaged, so that the rotational force can be continuously transmitted to the output shaft OS. In the same manner as when in first gear, the third drive gear G3 is coupled to the first synchronizer S1 and thus enters a pre-select state to prepare shifting to the next gear.

With reference to FIG. 3, when in third or higher gear or reverse gear, the first and second clutches C1 and C2 are alternately or selectively engaged and disengaged to transmit power to the corresponding gear. Furthermore, during this operation, a drive gear corresponding to the next gear in relation to the current gear is previously selected and thus stands by in the pre-select state, in the same manner as that of the first and second gears. As such, gear shifting between the first through seventh gears can be rapidly conducted in succession. When in reverse gear, the fourth synchromesh S4 engages with the eighth drive gear G8 which is the reverse gear, so that the rotational force is transmitted to a reverse driven gear R through an idling gear IG.

Such gear shifting can be manually or automatically conducted using a shift button, a shift paddle or a typical shift lever. The coaxial multi-clutch transmission has the advantages of manual gear shifting mechanism despite having no clutch pedal. The reason that a clutch pedal is not required is because gear shifting is automatically conducted by an electronic hydraulic actuator. In other words, because the transmission of the present invention is configured such that shifting to the pre-selected next gear can be continuously conducted without an interval by alternately operating the two clutches C1 and C2, the ON-OFF operation of a clutch pedal is not required unlike the manual transmission. The electronic control unit of the vehicle determines the next gear to be selected by the driver from data which is read from the position of a throttle and an rpm counter.

Here, when the second drive gear G2 which is related to the second gear ratio is being operated, the second clutch C2 related to the odd-numbered gear ratios is in the disengaged state. Thus, even though the third drive gear G3 for third gear shifting is in the pre-select state, it does not affect the second drive gear G2 which is being operated. When the driver manipulates, e.g., the shift pedal, the electronic control unit transmits a signal by which the first clutch C1 for the even-numbered gear ratios is disengaged and the second clutch C2 for the odd-numbered gear ratios is simultaneously engaged. In this manner, the gear can be rapidly shifted from second to third gear without an interceding interval. Therefore, unlike the manual transmission, there isn't a period of time when the power connection is completely released. As a result, the operation of shifting gears can be rapidly and smoothly conducted without any interceding interval.

The coaxial multi-clutch transmission of the present invention having the above-mentioned construction and operation can overcome the limitation of the conventional axial dual-clutch transmission which must use only small wet multi-plate clutches because of structural characteristics thereof. In other words, a dry single-plate clutch can be used in the present invention. In the case where the dry single-plate clutch is used as each clutch of the coaxial multi-clutch transmission, a hydraulic pressure controller which is required to operate the wet multi-plate clutch but causes parasitic energy consumption of the output of the engine is not required. Thus, the fuel efficiency can be enhanced. Furthermore, the dry single-plate clutch can be easily designed such that the diameter thereof is greater than that of the wet multi-plate clutch. Thereby, the maximum allowed torque of the clutch is increased. As a result, the coaxial multi-clutch transmission can be used in larger vehicles, such as buses, trucks, etc. which require a relatively large load. In addition, the coaxial multi-clutch transmission can also be effectively used in a small vehicle having a relatively low engine output, because there is no hydraulic pressure controller which causes parasitic energy consumption. To date, the conventional coaxial dual-clutch transmission has been used only in expensive sedans or sports cars, but the coaxial multi-clutch transmission according to the present invention can be applied to a larger variety of vehicles.

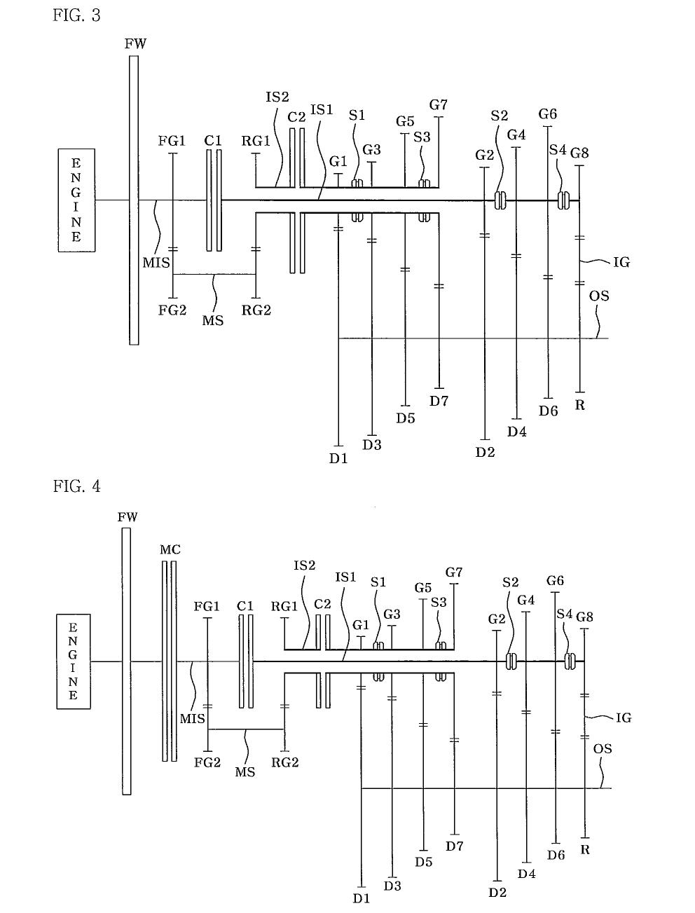

FIG. 4 is a schematic view illustrating a coaxial multi-clutch transmission, according to a second embodiment of the present invention. The general construction of the second embodiment, other than having a separate main clutch MC provided ahead of the first and second clutches C1 and C2, remains the same as that of the first embodiment. In the second embodiment, the main clutch MC which comprises a third clutch is provided on a main input shaft MIS between a flywheel FW and a first front gear FG1. It is preferable that the main clutch MC comprise a dry single-plate clutch. The main clutch MC is set such that the size (diameter) and the maximum allowed torque thereof be greater than those of the first or second clutch C1 or C2. As such, the coaxial multi-clutch transmission according to the second embodiment is markedly different from the first embodiment because it has three clutches.

When the components of the second embodiment are arranged in order from large to small, they can be arranged in a sequence of the flywheel FW, the main clutch MC and the first and second clutches C1 and C2. The operation of the coaxial multi-clutch transmission of the second embodiment having the triple clutch structure slightly differs from that of the first embodiment. In the second embodiment, when the vehicle starts in first gear from the stationary state, the second clutch C2 is already in the engaged state, and the main clutch MC which has been in the disengaged state is engaged so that the rotational force is transmitted to the output shaft OS through the second clutch C2. When the vehicle moves in reverse gear, the first clutch C1 is already in the engaged state, and the main clutch MC which has been in the disengaged state is engaged so that the rotational force is transmitted to the output shaft OS through the first clutch C1.

In this case, even though the vehicle begins to move in the upward direction on a relatively steep slope, the transmission can easily overwhelm the amount of static friction without the clutch slipping, because the main clutch MC which has a large diameter and a wide area governs the connection and interruption of power. Therefore, the operation of the transmission is very reliable. Furthermore, the main clutch MC is smaller than the flywheel FW, and the first and second clutches C1 and C2 can be formed smaller than those of the first embodiment which has no main clutch MC. Thus, the use of the main clutch MC may reduce the entire volume of the gearbox of the transmission more than when there is no main clutch MC. After the vehicle begins to move, the main clutch MC maintains the engaged state, and the first and second clutches C1 and C2 are alternately selected and operated to shift to a higher gear. Therefore, shifting gears after the vehicle has begun to move is the same as that of the first embodiment, thus further explanation is deemed unnecessary.

In the second embodiment, even though the size of the main clutch MC is increased by a great deal, the volume of the gear box can remain the same. Hence, the transmission of the second embodiment can be effectively used even in large vehicles, such as buses or trucks, which mainly use a dry clutch that is comparatively very large. Furthermore, the transmission of the second embodiment may be configured such that the main clutch MC has a dry clutch structure suitable to coping with high torque and the first and second clutches C1 and C2 are wet multi-plate clutch structures. In addition, the main clutch MC may comprise one selected from the group including a dry clutch, a multi-plate clutch and a torque converter of an automatic transmission.

The operational mechanism of the transmission of the second embodiment having the triple-clutch structure will be explained in more detail.

In order that the vehicle starts in first gear (G1, D1) from the stationary state, the second clutch C2 which can have a relatively small size is in the engaged state and the first clutch C1 is in the disengaged state. From this state, the gear is shifted to first gear and the main clutch MC which has been in the disengaged state is simultaneously engaged. Thus, power is transmitted from the engine to the second input shaft IS2. Thereby, the rotational force is transmitted to the output shaft OS through the first drive gear G1 which is a first speed change gear and the driven gear D1. When shifting to second or higher gear, the main clutch MC stays in the engaged state, and only the first and second clutches C1 and C2 alternately enter the engaged state and the disengaged state, in the same manner as that of the transmission of the first embodiment.

In the operation of shifting to reverse gear, the first clutch C1 is in the engaged state and the second clutch C2 is in the disengaged state. Furthermore, when shifting into reverse gear, the main clutch MC which has been in the disengaged state enters the engaged state so that the power connection is made. At this time, because only the first clutch C1 is in the engaged state, the rotational force of the main input shaft MIS is directly transmitted to the first input shaft IS1 and is then transmitted to the output shaft OS through the reverse driven gear R. As such, in this embodiment, when a relatively high torque is required due to high friction, for example, when the vehicle starts to move forwards or rearwards from the stationary state, the main clutch MC which has a relatively large size conducts the function of connecting or disconnecting power. When gear shifting is required after the vehicle begins to move, the first and second clutches C1 and C2 which may have relatively small sizes can rapidly conduct the gear shifting.

The coaxial multi-clutch transmission according to the second embodiment is very useful in that it can be effectively used even in large vehicles, such as buses or trucks. Moreover, in the second embodiment, because the main clutch MC can govern the first driven gear D1 to which relatively large torque (load) is applied, the first and second clutches C1 and C2 can be formed smaller than those of the first embodiment having no main clutch MC. In FIG. 4, the sizes of the first and second clutches C1 and C2 are illustrated as being equal to each other.

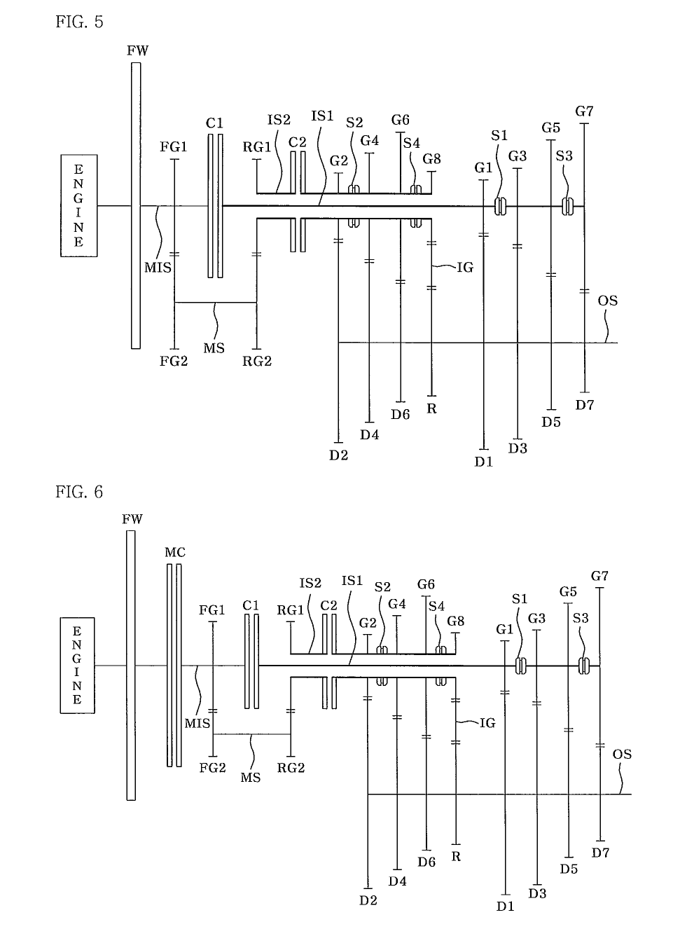

FIG. 5 is a schematic view illustrating a coaxial multi-clutch transmission, according to a third embodiment of the present invention. The basic construction of the coaxial multi-clutch transmission according to the third embodiment is the same as that of the coaxial multi-clutch transmission of the first embodiment. Only, in the third embodiment, odd-numbered speed drive gears G1, G3, G5 and G7 are provided on a first input shaft IS1, and even-numbered speed drive gears G2, G4, G6 and R are provided on a second input shaft IS2, unlike the first or second embodiment. The general construction and operational mechanism of the third embodiment other than the above-mentioned structure remain the same as those of the first embodiment, therefore repeated explanation will be omitted.

FIG. 6 is a schematic view illustrating a coaxial multi-clutch transmission, according to a fourth embodiment of the present invention. In the same manner as the second embodiment of FIG. 4, a main clutch MC is added to the same construction as that of the third embodiment. Therefore, the general construction and operational mechanism of the transmission of the fourth embodiment, besides the arrangement of the odd-numbered and even-numbered speed drive gears on the input shafts, remain the same as those of the second embodiment of FIG. 4, therefore further explanation is deemed unnecessary.

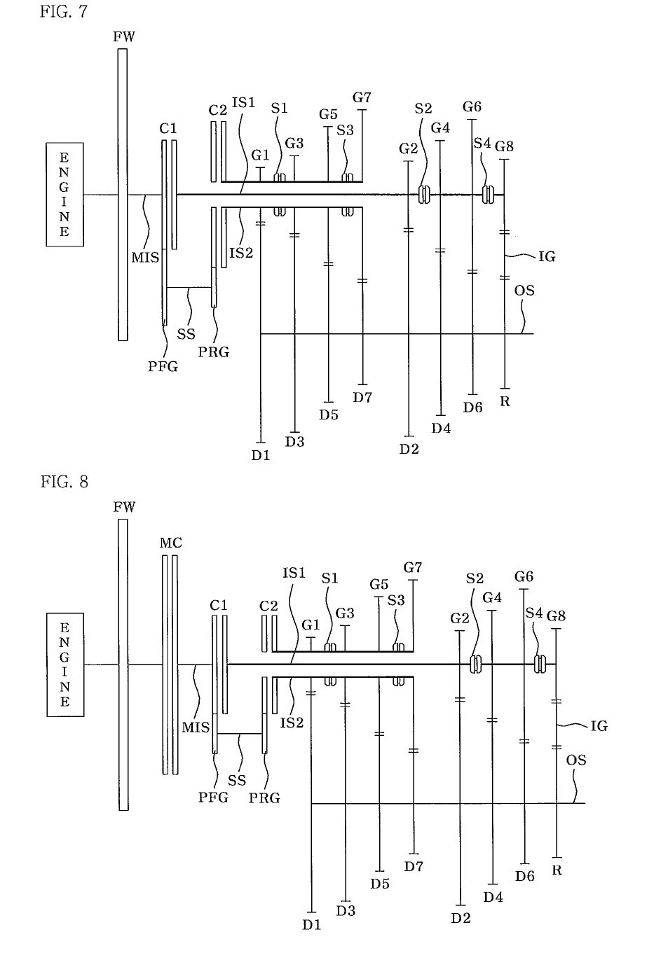

FIG. 7 is a schematic view illustrating a coaxial multi-clutch transmission, according to a fifth embodiment of the present invention. The fifth embodiment is characterized by the structure of a power transmitting gear unit which transmits rotational force from a main input shaft MIS to a second input shaft IS2. In detail, the power transmitting gear unit of the fifth embodiment includes an auxiliary shaft SS, a front power transmitting gear PFG and a rear power transmitting gear PRG. The auxiliary shaft SS is provided parallel to the main input shaft MIS. The front power transmitting gear PFG is rotatably provided on the auxiliary shaft SS and engages with a first clutch C1. The rear power transmitting gear PRG is rotatably provided on the auxiliary shaft SS and engages with a second clutch C2. This structure of the power transmitting gear unit is advantageous in that the size of the coaxial multi-clutch transmission can be further reduced.

The rotational force of the main input shaft MIS can be transmitted to the second input shaft IS2 through the front power transmitting gear PFG and the rear power transmitting gear PRG. The power transmission between the input shafts is selectively controlled by the first and second clutches C1 and C2. A method of engaging the first clutch C1 with the front power transmitting gear PFG or a method of engaging the second clutch C2 with the rear power transmitting gear PRG is not limited to any special method. For instance, the method may comprise any one of various methods which are well known in the art.

The general operational mechanism of this embodiment is the same as that of the prior embodiments. For example, when the first clutch C1 is operated, the rotational force of the main input shaft MIS is transmitted to the first input shaft IS1, and the second clutch C2 stays in the disengaged state. When the second clutch C2 is operated, the rotational force of the main input shaft MIS is transmitted to the second input shaft IS2, and the first clutch C1 maintains the disengaged state. However, the fifth embodiment differs from the prior embodiments in that the rotational force of the engine is transmitted to the second input shaft IS2 via the main input shaft MIS, the front power transmitting gear PFG and the rear power transmitting gear PRG of the power transmitting gear unit. The remaining construction and operational mechanism of the transmission of the fifth embodiment, other than the above-mentioned structure and operational mechanism, remain the same as those of the prior embodiments, therefore repeated explanation will be omitted.

FIG. 8 is a schematic view illustrating a coaxial multi-clutch transmission, according to a sixth embodiment of the present invention. The general construction of the transmission of the sixth embodiment is similar to that of the fifth embodiment. However, in the sixth embodiment, a separate main clutch MC is provided ahead of first and second clutches C1 and C2, unlike in the fifth embodiment. As such, the sixth embodiment is characterized in that the main clutch MC acting as a third clutch is provided between a flywheel FW and the first clutch C1, in other words, a total of three clutches are used.

That is, in the sixth embodiment, the construction of the power transmitting gear unit which transmits the rotational force of the engine to the second input shaft IS2 is the same as that of the embodiment of FIG. 7. Furthermore, the construction of the sixth embodiment is similar to that of the embodiment having the three clutches of FIG. 4 in that the separate main clutch MC is provided on the main input shaft MIS. The techniques common to the embodiments of FIGS. 4 and 7 can be applied to the sixth embodiment, for example, the size of the main clutch MC is greater than that of the first or second clutch C1 or C2 such that the maximum allowed torque can be increased, therefore repeated explanation will be omitted.

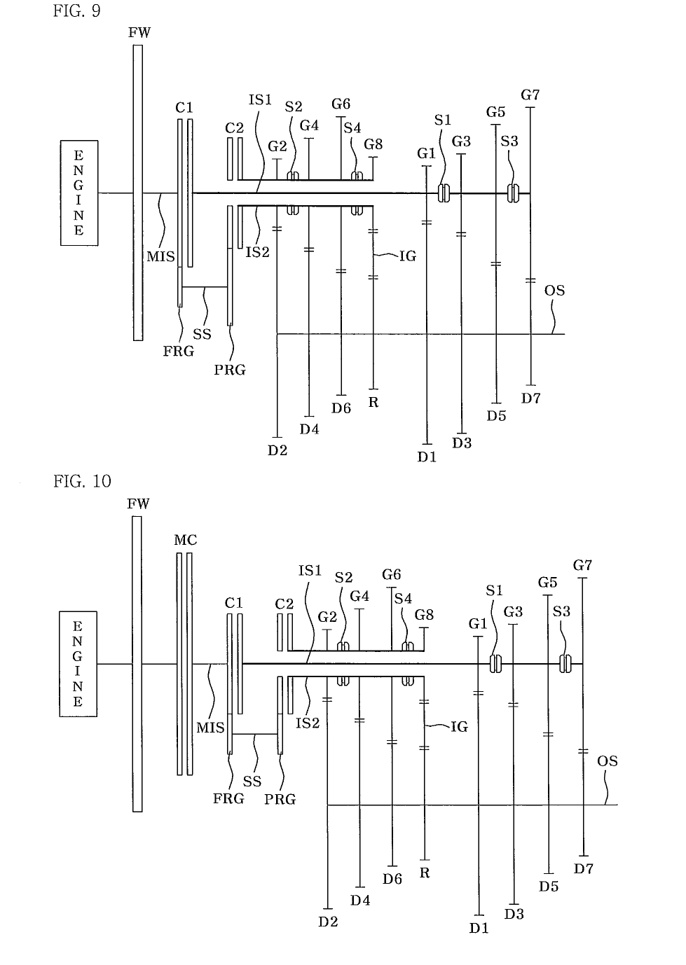

FIG. 9 is a schematic view illustrating a coaxial multi-clutch transmission, according to a seventh embodiment of the present invention. The basic construction of the coaxial multi-clutch transmission according to the seventh embodiment is the same as that of the fifth embodiment. Only, in the seventh embodiment, odd-numbered speed drive gears G1, G3, G5 and G7 are provided on a first input shaft IS1, and even-numbered speed drive gears G2, G4, G6 and R are provided on a second input shaft IS2, unlike the fifth embodiment. Furthermore, in consideration of the fact that the largest torque (load) is applied in first gear, the size of the first clutch C1 which governs the odd-numbered speed drive gears including the first drive gear related to the first gear ratio is greater than that of the second clutch C2 which governs the even-numbered speed drive gears. The general construction and operational mechanism of the sixth embodiment other than the above-mentioned structure remain the same as those of the fifth embodiment, therefore repeated explanation will be omitted.

FIG. 10 is a schematic view illustrating a coaxial multi-clutch transmission, according to an eighth embodiment of the present invention. In the same manner as the sixth embodiment illustrated in FIG. 8, a main clutch MC is added to the same construction as that of the seventh embodiment. Therefore, the general construction and operational mechanism of the transmission of the eighth embodiment, besides for the arrangement of the odd-numbered and even-numbered speed drive gears on the input shafts, remain the same as those of the sixth embodiment of FIG. 8, therefore further explanation is deemed unnecessary.

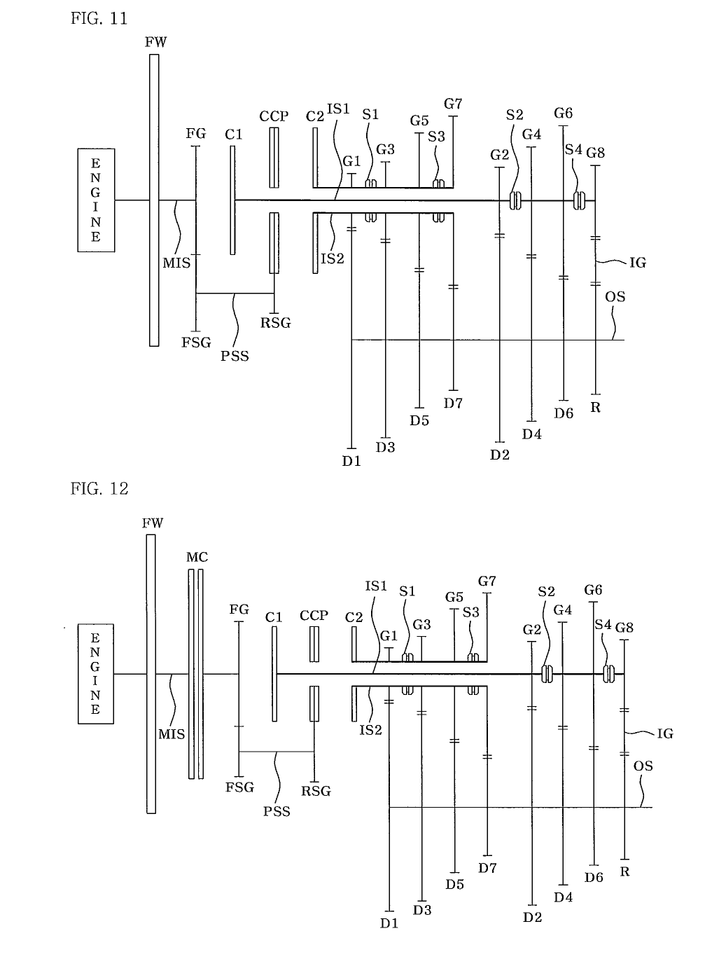

FIG. 11 is a schematic view illustrating a coaxial multi-clutch transmission, according to a ninth embodiment of the present invention. The transmission according to the ninth embodiment is characterized by a first clutch C1 provided on a first input shaft IS1, a second clutch C2 provided on a second input shaft IS2, and a center clutch plate CCP provided between the first clutch C1 and the second clutch C2. The center clutch plate CCP is engaged with or disengaged from the first clutch C1 or the second clutch C2 to transmit power from the main input shaft MIS to the first input shaft IS1 or the second input shaft IS2. Compared to the prior embodiments which provide a double clutch structure including two independent clutches, the ninth embodiment is configured such that the two clutches use the center clutch plate CCP in common, thus simplifying the entire structure of the transmission.

Furthermore, the ninth embodiment provides a power transmitting gear unit having the following construction such that rotational force is appropriately transmitted to the corresponding input shaft when the two clutches use the center clutch plate in common. In detail, the power transmitting gear unit includes a front gear FG, a power supply shaft PSS, a front supply gear FSG and a rear supply gear RSG. The front gear FG is disposed between the main input shaft MIS and the first clutch C1 and is rotatably provided on the main input shaft MIS. The power supply shaft PSS is provided parallel to the main input shaft MIS. The front supply gear FSG is rotatably provided on the power supply shaft PSS and engages with the front gear FG. The rear supply gear is rotatably provided on the power supply shaft PSS and engages with the center clutch plate CCP. The remaining construction of the transmission of the ninth embodiment other than the clutch structure including the center clutch plate and the power transmitting gear unit is almost the same as that of the first embodiment. The operational mechanism of the transmission according to the ninth embodiment having the above-mentioned construction will be explained in detail with reference to FIG. 11.

When in first gear, the first drive gear G1 which engages with the first driven gear D1 makes the power connection. In detail, the rotational force of the engine is transmitted to the center clutch plate CCP via the main input shaft MIS and the power transmitting gear unit including the front gear FG, the front supply gear FSG, the power supply shaft and the rear supply gear RSG. In this case, the second clutch C2 engages with the center clutch plate CCP, so that the rotational force is transmitted from the center clutch plate CCP to the second clutch C2. The first synchronizer S1 is coupled to the first drive gear G1 to transmit the rotational force to the first drive gear G1. Because the first drive gear G1 engages with the first driven gear D1, the rotational force of the engine is transmitted to the differential gear (not shown) via the first driven gear D1 and the output shaft OS. During this process, the second synchronizer S2 maintains a pre-select state of being engaged beforehand with the second drive gear G2 to prepare shifting to the next gear and also stays in the idle state.

When in second gear, the second drive gear G2 which engages with the second driven gear D2 makes a power connection. In detail, when shifting to second gear, the second clutch C2 is disengaged from the center clutch plate CCP, and the first clutch C1 is engaged with the center clutch plate CCP, so that the rotational force is transmitted to the first input shaft IS1. At this time, because the second drive gear G2 has been in the pre-select state, the rotational force is transmitted to the second driven gear D2 as soon as the first clutch C1 is engaged, so that the rotational force can be continuously transmitted to the output shaft OS. In the same manner as when in first gear, the third drive gear G3 is coupled to the first synchronizer S1 and thus enters a pre-select state to prepare shifting to the next gear.

With reference to FIG. 11, when in third or higher gear or reverse gear, the first and second clutches C1 and C2 are alternately or selectively engaged with and disengaged from the center clutch plate CCP to transmit the rotational force to the corresponding gear. Furthermore, during this operation, a drive gear corresponding to the next gear in relation to the current gear is previously selected and thus stands by in the pre-select state, in the same manner as that in the first and second gears. As such, gear shifting between the first through seventh gears can be rapidly conducted in succession. When in reverse gear, the fourth synchromesh S4 engages with the eighth drive gear G8 which is the reverse gear, so that the rotational force is transmitted to the reverse driven gear R through the idling gear IG.

FIG. 12 is a schematic view illustrating a coaxial multi-clutch transmission, according to a tenth embodiment of the present invention. The general construction of the transmission of the tenth embodiment, other than having a separate main clutch MC provided between the flywheel FW and the front gear FG, remains the same as that of the ninth embodiment. It is preferable that the main clutch MC comprise a dry single-plate clutch. The main clutch MC is preferably set such that the size and the maximum allowed torque thereof be greater than those of the first or second clutch C1 or C2. The technical characteristics of the construction in which the separate main clutch MC is added to the construction of the ninth embodiment were sufficiently explained in the description of the second embodiment. The remaining elements of the construction and operational mechanism of the tenth embodiment other than the above-mentioned structure are almost the same as those of the first embodiment, thus detailed explanation will be omitted.

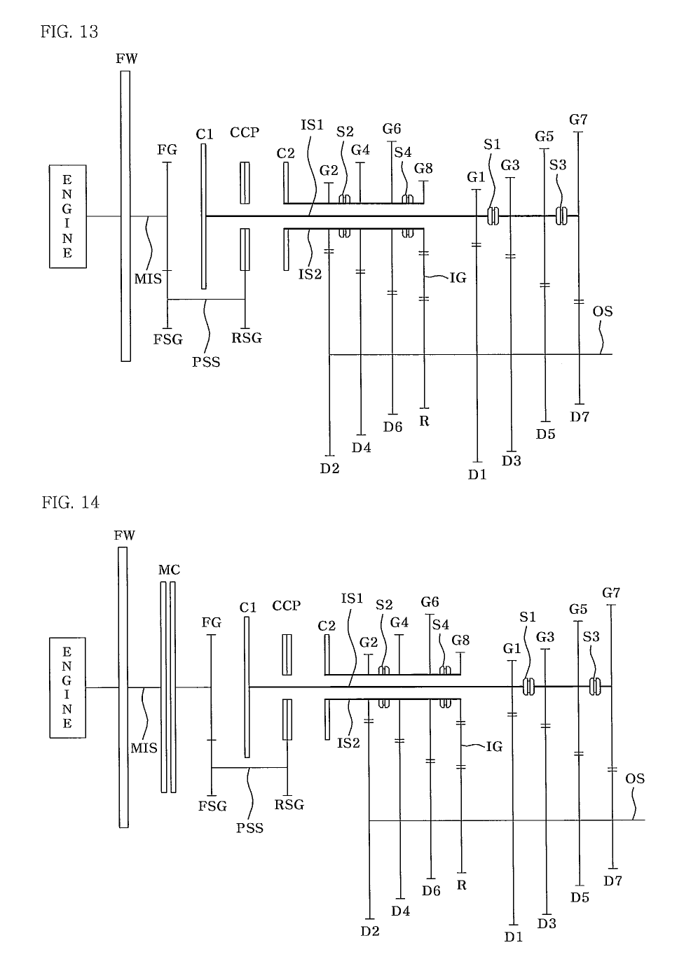

FIG. 13 is a schematic view illustrating a coaxial multi-clutch transmission, according to an eleventh embodiment of the present invention. The basic construction of the coaxial multi-clutch transmission of the eleventh embodiment is the same as that of the ninth embodiment. Only, in the eleventh embodiment, odd-numbered speed drive gears G1, G3, G5 and G7 are provided on a first input shaft IS1, and even-numbered speed drive gears G2, G4, G6 and R are provided on a second input shaft IS2, unlike the ninth embodiment. The general construction and operational mechanism of the eleventh embodiment besides for the above-mentioned structure remain the same as those of the ninth embodiment, therefore further explanation will be omitted.

FIG. 14 is a schematic view illustrating a coaxial multi-clutch transmission, according to a twelfth embodiment of the present invention. In the same manner as the tenth embodiment of FIG. 12, a main clutch MC is added to the same construction as that of the ninth embodiment. Therefore, the general construction and operational mechanism of the transmission of the twelfth embodiment, other than the arrangement of the odd-numbered and even-numbered speed drive gears on the input shafts, remain the same as those of the tenth embodiment of FIG. 12, for example, in that the size of the main clutch MC is set such that the maximum allowed torque thereof is greater than that of the first or second clutch C1 or C2. Therefore, further explanation is deemed unnecessary. Only, in the twelfth embodiment, unlike other embodiments having the structure including the main clutch MC, although the first clutch is illustrated as being larger than the second clutch, the second clutch may be larger than the first clutch or, alternatively, the first and second clutches may be of the same size.

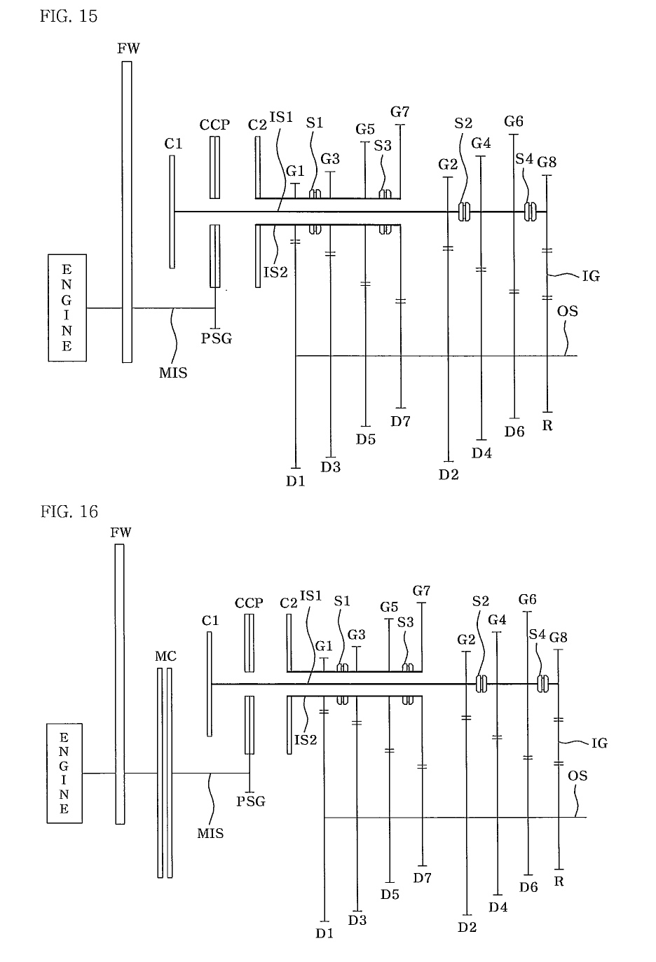

FIG. 15 is a schematic view illustrating a coaxial multi-clutch transmission, according to a thirteenth embodiment of the present invention. The transmission of the thirteenth embodiment is characterized by a clutch structure and a power supply gear PSG. In the same manner as the ninth embodiment, the clutch structure includes a first clutch C1 provided on the first input shaft IS1, a second clutch C2 provided on the second input shaft IS2, and a center clutch plate CCP which is provided between the first clutch C1 and the second clutch C2 and is selectively engaged with the first or second clutch C1 or C2. The power supply gear PSG is rotatably provided on the main input shaft MIS and engages with the center clutch plate CCP to transmit the rotational force to the center clutch plate CCP.

The thirteenth embodiment is configured such that the main input shaft MIS is parallel to the first and second input shafts IS1 and IS2. Thus, the rotational force of the engine is transmitted to the center clutch plate CCP only through the power supply gear PSG. Hence, this embodiment can further simplify the construction of the power transmitting gear unit proposed in the ninth embodiment. The operational mechanism of the thirteenth embodiment, other than the fact that the rotational force is transmitted from the engine to the center clutch plate CCP through the power supply gear PSG, is almost the same as that of the ninth embodiment. Thus, detailed explanation will be omitted.

FIG. 16 is a schematic view illustrating a coaxial multi-clutch transmission, according to a fourteenth embodiment of the present invention. The general construction of the transmission of the fourteenth embodiment, other than having a separate main clutch MC provided between the flywheel FW and the power supply gear, remains the same as that of the thirteenth embodiment. It is preferable that the main clutch MC comprise a dry single-plate clutch. The main clutch MC is preferably set such that the size and the maximum allowed torque thereof be greater than those of the first or second clutch C1 or C2. The technical characteristics of the construction in which the separate main clutch MC is added to the construction of the thirteenth embodiment were sufficiently explained in the description of the second embodiment. The remaining construction and operational mechanism of the fourteenth embodiment other than the above-mentioned structure is almost the same as those of the thirteenth embodiment, thus detailed explanation will be omitted. Furthermore, in the fourteenth embodiment, unlike other embodiments having the structure including the main clutch MC, although the second clutch is illustrated as being larger than the first clutch, the first clutch may be larger than the second clutch or, alternatively, the first and second clutches may have the same size.

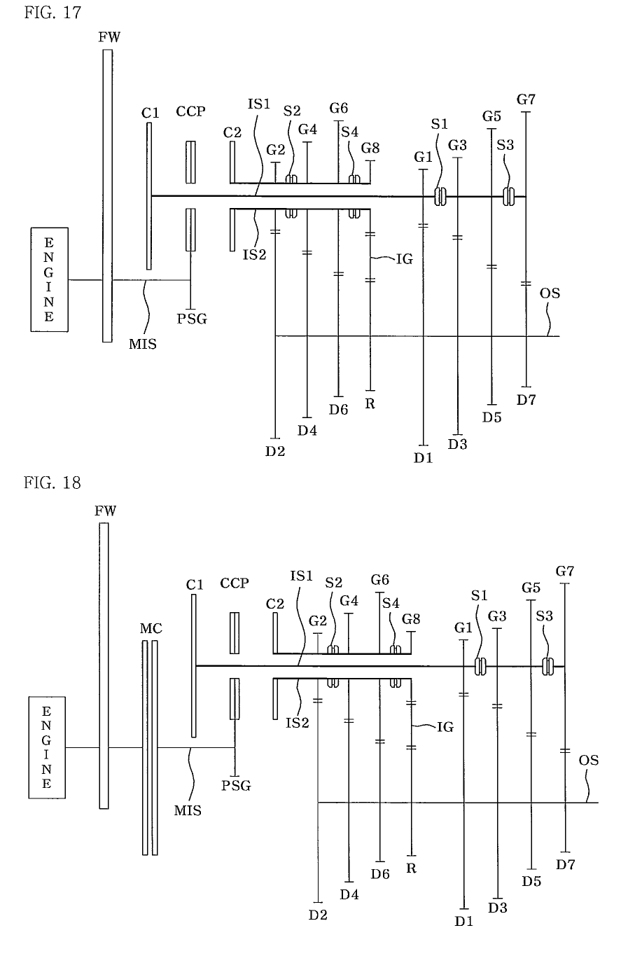

FIG. 17 is a schematic view illustrating a coaxial multi-clutch transmission, according to a fifteenth embodiment of the present invention. The basic construction of the transmission of the fifteenth embodiment is the same as that of the thirteenth embodiment of FIG. 15. Only, in the fifteenth embodiment, odd-numbered speed drive gears G1, G3, G5 and G7 are provided on a first input shaft IS1, and even-numbered speed drive gears G2, G4, G6 and R are provided on a second input shaft IS2, unlike in the thirteenth embodiment. The remaining construction and operational mechanism of the fifteenth embodiment other than the above-mentioned structure remain the same as those of the thirteenth embodiment, therefore further explanation will be omitted.

FIG. 18 is a schematic view illustrating a coaxial multi-clutch transmission, according to a sixteenth embodiment of the present invention. In the same manner as the fourteenth embodiment of FIG. 16, a main clutch MC is added to the same construction as that of the fifteenth embodiment. Therefore, the general construction and operational mechanism of the transmission of the sixteenth embodiment, other than the arrangement of the odd-numbered and even-numbered speed drive gears on the input shafts, remain the same as those of the fourteenth embodiment of FIG. 16, for example, in that the size of the main clutch MC is set such that the maximum allowed torque thereof is greater than that of the first or second clutch C1 or C2. Therefore, further explanation is deemed unnecessary. Only, in the sixteenth embodiment, although the first clutch is illustrated as being larger than the second clutch, the second clutch may be larger than the first clutch or, alternatively, the first and second clutches may be the same size.

In the preferred embodiments of the present invention, although the single output shaft OS has been illustrated as being provided below the input shafts IS1 and IS2, two output shafts may be respectively provided above and below the input shafts IS1 and IS2 such that they are parallel thereto. In this case, driven gears D1 through D7 and R may be divided into two groups which are respectively provided on the two output shafts. Furthermore, in the preferred embodiments, although the synchronizers S1 through S4 have all been illustrated as being provided on the first input shaft IS1 and the second input shaft IS2, the present invention is not limited thereto. For example, when necessary, the synchronizers S1 through S4 may be disposed between the driven gears of the output shaft OS or provided on the input shafts or the output shaft.

As described above, a coaxial multi-clutch transmission according to the present invention can use a dry single-plate clutch, unlike the conventional coaxial dual-clutch transmission that must use only the wet multi-plate clutches because of the structural characteristics. As necessary, dry and/or wet clutches may be combined and arranged in various manners. Therefore, freedom of design of the transmission can be enhanced.

Furthermore, the present invention can prevent parasitic energy consumption which occurs in a hydraulic pressure controller that is used with the conventional wet multi-plate clutch. Thus, the fuel efficiency can be enhanced. The maximum allowed torque can be markedly enhanced compared to the conventional technique using the small wet multi-plate clutch. Therefore, the present invention can be used in not only small vehicles but also large vehicles, such as buses or trucks, which require high maximum allowed torque.

In addition, the present invention can markedly reduce the entire size of the transmission even though it enjoys the above-mentioned advantages. Thereby, freedom of design of an engine room can be enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A coaxial multi-clutch transmission providing speed and torque conversions from an engine to an output unit, comprising:
a main input shaft coupled to a flywheel to receive rotational force from the engine;
a first input shaft and a second input shaft disposed behind the main input shaft so as to be rotatable, the first and second input shafts being power-connected to the main input shaft such that the rotational force is transmitted from the main input shaft to the first or second input shaft, the second input shaft having a hollow shaft structure which is coaxial with the first input shaft and rotatably receiving the first input shaft therein;
a first clutch provided on the first input shaft, the first clutch allowing power connection from the main input shaft to the first input shaft or interrupting the power connection therebetween;
a second clutch provided on the second input shaft, the second clutch allowing power connection from the main input shaft to the second input shaft or interrupting the power connection therebetween;
a power transmitting gear unit, comprising:
a first front gear rotatably provided on the main input shaft between the flywheel and the first clutch;
a first rear gear rotatably provided on a front end of the second input shaft;
a middle shaft provided parallel to the main input shaft;
a second front gear rotatably provided on the middle shaft, the second front gear engaging with the first front gear; and
a second rear gear rotatably provided on the middle shaft, the second rear gear engaging with the first rear gear;
an output shaft provided parallel to the first and second input shafts which are coaxial, the output shaft being disposed at a position spaced apart from the first and second input shafts;
a plurality of drive gears rotatably provided on the first input shaft and the second input shaft; and
a plurality of driven gears rotatably provided on the output shaft, the driven gears engaging with the corresponding drive gears.

2. A coaxial multi-clutch transmission providing speed and torque conversions from an engine to an output unit, comprising:
a main input shaft coupled to a flywheel to receive rotational force from the engine;
a first input shaft and a second input shaft disposed behind the main input shaft so as to be rotatable, the first and second input shafts being power-connected to the main input shaft such that the rotational force is transmitted from the main input shaft to the first or second input shaft, the second input shaft having a hollow shaft structure which is coaxial with the first input shaft and rotatably receiving the first input shaft therein;
a first clutch provided on the first input shaft, the first clutch allowing power connection from the main input shaft to the first input shaft or interrupting the power connection therebetween;
a second clutch provided on the second input shaft, the second clutch allowing power connection from the main input shaft to the second input shaft or interrupting the power connection therebetween;
a power transmitting gear unit, comprising:
an auxiliary shaft provided parallel to the main input shaft;
a front power transmitting gear rotatably provided on the auxiliary shaft, the front power transmitting gear engaging with the first clutch; and
a rear power transmitting gear rotatably provided on the auxiliary shaft, the rear power transmitting gear engaging with the second clutch;
an output shaft provided parallel to the first and second input shafts which are coaxial, the output shaft being disposed at a position spaced apart from the first and second input shafts;
a plurality of drive gears rotatably provided on the first input shaft and the second input shaft; and
a plurality of driven gears rotatably provided on the output shaft, the driven gears engaging with the corresponding drive gears.

3. A coaxial multi-clutch transmission providing speed and torque conversions from an engine to an output unit, comprising:
a main input shaft coupled to a flywheel to receive rotational force from the engine;
a first input shaft and a second input shaft disposed behind the main input shaft so as to be rotatable, the first and second input shafts being power-connected to the main input shaft such that the rotational force is transmitted from the main input shaft to the first or second input shaft, the second input shaft having a hollow shaft structure which is coaxial with the first input shaft and rotatably receiving the first input shaft therein;
a first clutch provided on the first input shaft;
a second clutch provided on the second input shaft;
a center clutch plate provided between the first clutch and the second clutch, the center clutch plate being engaged with or disengaged from the first clutch or the second clutch to transmit the rotational force from the main input shaft to the first input shaft or the second input shaft;
a power transmitting gear unit, comprising:
a front gear provided between the main input shaft and the first clutch, the front gear being rotatably mounted to the main input shaft;
a power supply shaft provided parallel to the main input shaft;
a front supply gear rotatably provided on the power supply shaft, the front supply gear engaging with the front gear; and
a rear supply gear rotatably provided on the power supply shaft, the rear supply gear engaging with the center clutch plate;
an output shaft provided parallel to the first and second input shafts which are coaxial, the output shaft being disposed at a position spaced apart from the first and second input shafts;
a plurality of drive gears rotatably provided on the first input shaft and the second input shaft; and
a plurality of driven gears rotatably provided on the output shaft, the driven gears engaging with the corresponding drive gears.

4. A coaxial multi-clutch transmission providing speed and torque conversions from an engine to an output unit, comprising:
a main input shaft coupled to a flywheel to receive rotational force from the engine;
a first input shaft and a second input shaft disposed behind the main input shaft so as to be rotatable, the first and second input shafts being provided parallel to the main input shaft and power-connected to the main input shaft such that the rotational force is transmitted from the main input shaft to the first or second input shaft, the second input shaft having a hollow shaft structure which is coaxial with the first input shaft and rotatably receiving the first input shaft therein;
a first clutch provided on the first input shaft;
a second clutch provided on the second input shaft;
a center clutch plate provided between the first clutch and the second clutch, the center clutch plate being engaged with or disengaged from the first clutch or the second clutch to transmit the rotational force from the main input shaft to the first input shaft or the second input shaft;
a power supply gear rotatably mounted to the main input shaft, the power supply gear engaging with the center clutch plate;
an output shaft provided parallel to the first and second input shafts which are coaxial, the output shaft being disposed at a position spaced apart from the first and second input shafts;
a plurality of drive gears rotatably provided on the first input shaft and the second input shaft; and
a plurality of driven gears rotatably provided on the output shaft, the driven gears engaging with the corresponding drive gears.

5. The coaxial multi-clutch transmission as set forth in claim 1, wherein, of the plurality of drive gears, even-numbered speed drive gears are provided on the first input shaft, and odd-numbered speed drive gears are provided on the second input shaft.

6. The coaxial multi-clutch transmission as set forth in claim 1, wherein, of the plurality of drive gears, odd-numbered speed drive gears are provided on the first input shaft, and even-numbered speed drive gears are provided on the second input shaft.

7. The coaxial multi-clutch transmission as set forth in claim 1, further comprising:
a main clutch provided between the flywheel and the first clutch, the main clutch having a diameter greater than a diameter of each of the first and second clutches.

8. The coaxial multi-clutch transmission as set forth in claim 2, wherein, of the plurality of drive gears, even-numbered speed drive gears are provided on the first input shaft, and odd-numbered speed drive gears are provided on the second input shaft.

9. The coaxial multi-clutch transmission as set forth in claim 2, wherein, of the plurality of drive gears, odd-numbered speed drive gears are provided on the first input shaft, and even-numbered speed drive gears are provided on the second input shaft.

10. The coaxial multi-clutch transmission as set forth in claim 2, further comprising:
a main clutch provided between the flywheel and the first clutch, the main clutch having a diameter greater than a diameter of each of the first and second clutches.

11. The coaxial multi-clutch transmission as set forth in claim 3, wherein, of the plurality of drive gears, even-numbered speed drive gears are provided on the first input shaft, and odd-numbered speed drive gears are provided on the second input shaft.

12. The coaxial multi-clutch transmission as set forth in claim 3, wherein, of the plurality of drive gears, odd-numbered speed drive gears are provided on the first input shaft, and even-numbered speed drive gears are provided on the second input shaft.

13. The coaxial multi-clutch transmission as set forth in claim 3, further comprising:
a main clutch provided between the flywheel and the first clutch, the main clutch having a diameter greater than a diameter of each of the first and second clutches.

14. The coaxial multi-clutch transmission as set forth in claim 4, wherein, of the plurality of drive gears, even-numbered speed drive gears are provided on the first input shaft, and odd-numbered speed drive gears are provided on the second input shaft.

15. The coaxial multi-clutch transmission as set forth in claim 4, wherein, of the plurality of drive gears, odd-numbered speed drive gears are provided on the first input shaft, and even-numbered speed drive gears are provided on the second input shaft.

16. The coaxial multi-clutch transmission as set forth in claim 4, further comprising:
a main clutch provided between the flywheel and the first clutch, the main clutch having a diameter greater than a diameter of each of the first and second clutches.
